(19) United States
(12) Patent Application Publication
(10) Pub. No.: US 2012/0177562 A1
(43) Pub. Date: Jul. 12, 2012

(54) PROCESS FOR PRODUCING A CARBONACEOUS PRODUCT FROM BIOMASS

(75) Inventors: Roy Randall Lovel, Baringhup (AU); Malisja De Varies, Montmorency (AU)

(73) Assignee: COMMONWEALTH SCIENTIFIC AND INDUSTRIAL RESEARCH CORPORATION, Campbell (AU)

(21) Appl. No.: 13/388,938

(22) PCT Filed: Aug. 4, 2010
(86) PCT No.: PCT/AU2010/000984

§ 371 Date: Mar. 27, 2012

(30) Foreign Application Priority Data
Aug. 4, 2009 (AU) 2009903638

(51) Int. Cl. C01B 31/00; B01J 21/18

(52) U.S. Cl. 423/448; 502/180; 264/29.4

(57) ABSTRACT

A process for producing densified and at least partially graphitised carbonaceous product. The process includes the following steps: heating a biomass in an oxygen controlled atmosphere to a first temperature under compression to form a plastically deformed intermediate product and heating the plastically deformed intermediate product in an oxygen controlled atmosphere to a second temperature that is higher than the first temperature, while constraining the intermediate product to limit or avoid volume expansion to form the densified and at least partially graphitised carbonaceous product.

### TECHNICAL FIELD

The present invention relates to processes for the production of carbonaceous products and products formed by such processes. In particular, the invention relates to the production of carbonaceous products suitable for use in metallurgical applications.

### BACKGROUND

Petroleum coke is the primary source of material used in the manufacture of carbon-based products employed in a number of metallurgical processes. For example, petroleum coke is used to produce anodes that are required for aluminium production. Anodes used in the Hall-Heroult process are traditionally composed of petroleum coke bound with coal tar pitch (about 16 wt %).

Petroleum coke is derived from crude oil and, as supplies of this fossil fuel are diminishing, this has implications with respect to the production of petroleum coke and downstream production. The quality of crude oil has also been in decline in recent years and this leads to undesirable impurities in the resultant petroleum coke and products produced from petroleum coke. Increasing impurity levels in petroleum coke are of particular concern in the aluminium production industry. The highly reducing conditions within a Hall-Heroult cell ensure that impurities in carbon anodes, such as Fe and Si, will report to, contaminate and degrade the aluminium metal product. Other low level (ppm) impurities, such as V and Na can accelerate anode air-burn and CO₂ gas evolved in the process can lead to increased anode consumption. Fuel based sulphur in the smelter off-gases is a third area of concern where sulphur converts to SO₂ causing corrosion to ducting and requiring sophisticated scrubbing systems to prevent environmental problems such as acid rain. Smelters typically have SO₂ permit levels (around 2.75%) and cannot accept higher sulphur containing coke. Fundamentally, the anodes need to satisfy the electrical requirements of the process (such as high conductivity and density) as well as maintain or improve high levels of carbon purity and consequently, the industry is seeking carbon from alternative sources to address their anode material concerns.

Furthermore, society and various governments are responding to carbon constraints and other environmental concerns and alternative renewable sources of carbon are sought to satisfy sustainability and environmental issues, and lower overall CO₂ emissions with the subsequent growth of photosensitive dependant biomass.

Charcoal formed from lignocellulosic biomass in conventional pyrolysis processes has an open pore structure that contributes to its low density. Densification of charcoal by mechanical means, for example by pelletising, is difficult due to the inherent strength of the remaining cellular structure of the starting material. This causes “springback” when the load from the mechanical means is removed resulting in cracks or delamination and further increase in porosity.

The present invention seeks to provide an alternative pathway by which carbon-based products suitable for metallurgical processes can be produced that is less reliant on petroleum coke, that facilitates the production of high quality products and that is more environmentally responsible. In accordance with the present invention, biomass charcoal is proposed as a partial or total substitute for fossil carbon in the production of such carbon-based products.

### SUMMARY OF THE INVENTION

Accordingly, in one embodiment the present invention provides a process for producing densified and at least partially graphitised carbonaceous product, the process comprising:

heating a biomass in an oxygen controlled atmosphere to a first temperature under compression to form a plastically deformed intermediate product; and heating the plastically deformed intermediate product in an oxygen controlled atmosphere to a second temperature that is higher than the first temperature while constraining the intermediate product to limit or avoid volume expansion to form the densified and at least partially graphitised carbonaceous product.

The process of the invention involves subjecting biomass to process regimes involving the application of heat and pressure (compression) in order to achieve desirable structural changes in the biomass resulting in formation of a densified and at least partially graphitised carbonaceous product. Advantageously, the conditions applied may be manipulated in order to control the characteristics of the product that is produced, at least in terms of density and/or degree of graphitisation. The product may be produced in order to have a density higher than that of charcoal produced by conventional processes, so that it is suitable for use as a substitute for petroleum coke. For example, the at least partially graphitised carbonaceous product may be crushed or ground to be blended into the existing aluminium anode making process or used in other metallurgical processes including as a reductant in steel production.

The present invention also provides densified and at least partially graphitised products that may be produced in accordance with the present invention.

Further, the present invention also extends to practical (downstream) applications of the carbonaceous product that may be produced in accordance with the present invention. Per se the product may be used as a partial or complete replacement for metallurgical coal or petroleum coke. For example, the product can be utilised for partial blending with, or as a complete total substitute for, fossil carbon in many metallurgical processes. Thus, the product may be used instead of anthracite in arc furnaces, instead of coke in blast furnace operations, and instead of coke as a filler in the anode bake furnace. One particular application envisaged for the carbonaceous product is in the production of anodes for use in aluminium production.

### DETAILED DESCRIPTION

In a first step of the process of the present invention, biomass is heated to a first temperature under compression in order to effect plastic deformation. Herein the product of this step is termed a plastically deformed intermediate product. This first heating step is intended to cause pyrolysis (carbonation) of the biomass. Pyrolysis of biomass typically involves three broad stages that are temperature dependent—drying (at temperatures below 200° C.), pre-carbonation (at temperatures between about 200 and 300° C.) and carbonation (at temperatures from about 280 to 790° C.). In practice in the first process step, the biomass is heated from or about ambient to a particular elevated temperature so that the biomass transitions through each stage of pyrolysis. Thus, in the first heating step the temperature of the biomass is increased. The temperature increase may occur at the same or different rates in each of the various stages of pyrolysis.

To optimise the softening of the biomass, it may be heated at a controlled rate to ensure that all of the material is softened and to avoid significant disparities in the amount of heating and softening throughout the biomass. If the biomass is heated too quickly it may not be heated thoroughly, so that the exterior of the biomass begins to carbonise before the interior portion had adequately softened. The heating rate suitable for heating the biomass to the first temperature is dependent upon the type, geometry and amount of biomass. However, rates are typically in the range of about 20 to about 250° C. per hour, and rates in the order of 100° C. per hour have been found to be particularly useful. The rates can vary depending on the form of biomass (solid or granular) or the biomass species.

The temperature of the biomass may also be maintained at a particular value or within a range of values so that one or more stages of pyrolysis is maintained as desired.

During this heating step, low molecular weight volatiles are released from the biomass and these must be removed. In effect this causes a reduction in the content of oxygen, hydrogen and nitrogen components of the biomass. Accordingly, during pyrolysis there is mass loss from the biomass.

This first heating step takes place in an oxygen controlled atmosphere. By “an oxygen controlled atmosphere” is meant an atmosphere having an oxygen content lower than a level at which combustion of the biomass during heating is at risk of occurring. The first heating step may take place in the absence of oxygen, for example in a reducing or semi-reducing atmosphere, to avoid oxidation of carbon and readily maximize char yields. For example, the oxygen controlled atmosphere may be provided by conducting the process under nitrogen gas. It will be appreciated that in such embodiments, some oxygen can be present in the biomass as air retained within the pores of the biomass and oxygen containing compounds in the biomass itself. The amount of oxygen introduced into the process by the biomass depends upon the type of biomass used and whether it has been subjected to any pre-treatment to reduce its oxygen content.

Alternatively, in some embodiments, it may be desirable to have an oxygen controlled atmosphere having a predetermined oxygen content in order to promote the release of some lower molecular weight volatiles from the biomass. In some cases, oxygen can enhance cleavage of bonds in some organic compounds and may also enhance production of certain products, such as some oils, from the biomass.

The first heating step may be performed in air provided that combustion is avoided. As the likelihood of combustion increases with temperature, the first heating step may be performed under air at the beginning of the process and then the air and associated oxygen may be purged from the system as the temperature increases. The amount of oxygen will reach a minimum before carbonization, often at around 280° C. In some embodiments, the oxygen may be replaced with an inert gas. When air is present, it is believed that the volatiles released during heating may drive off the air thereby further reducing the likelihood of combustion.

The optimum amount of oxygen present in practice of the invention may be determined by routine experimentation.

Heating of the biomass in the first heating step causes the biomass to soften, and during this heating step the biomass is also compressed causing plastic deformation of the softened biomass. This results in a reduction in pore size and surface area and an increase in density without substantially reducing the structural integrity of the biomass. Plastic deformation of the biomass under an applied compressive load may occur without cleavage or fracture of the tissue cells in the biomass, thereby maintaining the inherent strength and stiffness of the overall biomass cellular structure.

Compression of the biomass may be achieved in a number of ways. A static load may be applied, for example during batch production of the plastically deformed intermediate product. Alternatively, dynamic load compression can be used in a continuous production process. In some embodiments, dynamic compression may be achieved using a series of successive rollers or a screw feeding system.

A wide range of loads may be applied to the biomass during first stage at the process. The compressive load may be selected based upon the initial density of the biomass and the desired density of the intermediate product and final carbonaceous product. The final compressive load may be achieved by increasing the load applied in a series of discrete steps. Alternatively, the load may be increased continuously at a prescribed rate until the desired peak load is reached. Typical rates of load application include instantly to a progressive change at a rate of 100 kg/cm²/hour. The compressive load applied may be to a pressure less than the compressive strength of the biomass. Loads in the range of about 5 to about 50 kg/cm² and usually around about 25 kg/cm² have been found useful.

Selection of the maximum temperature and the compressive load applied in the first step is dependent upon the type of biomass used. As used herein the term “biomass” includes a variety of woody and herbaceous plant material, which can generally be characterised as lignocellulosic in nature. The term embraces biomass timber and wood residues, such as wood chips or sawdust, plant parts, fruits, vegetables, plant processing waste, chaff, grain, grasses, corn, corn husks, weeds, aquatic plants, hay, paper and paper products, and any cellulose containing biological material.

Before being used in the process of the present invention, the biomass may be pretreated. For example, the biomass may be physically pre-treated by heating, pelletizing or briquetting. Physically pre-treating the biomass may improve initial packing of the biomass so that plastic deformation can be performed more efficiently.

In some embodiments, the biomass may be chemically pre-treated to remove impurities, such as minerals including calcium, magnesium, iron and silica, from the biomass and to reduce the ash content. The chemical pre-treatment may include leaching impurities from the biomass using an acid or an alkali solution. In embodiments where acid leaching is used, the acid may catalyse hydrolysis of polysaccharides in the biomass to their monomeric constituents, and these in turn may be converted to valuable chemical products.

In some embodiments, chemical pre-treatment may be used to incorporate additives for catalysing or binding purposes.

Lignocellulosic biomass typically comprises three polymers; cellulose, hemicellulose and lignin. These polymers are viscoelastic materials, particularly the amorphous polymers in the biomass—lignin and hemicellulose. At temperatures below the glass transition temperature of these polymers, they may display elastic behaviour for small deformations. However, at higher temperatures these polymers have viscous or liquid-like mechanical characteristics. At intermediate temperatures, the polymers display the combined mechanical characteristics of the two extremes, that is, viscoelastic behaviour. Lignocellulosic biomass is porous and generally comprises hollow cellulose-rich fibres within a lignin-based matrix. Mass loss during pyrolysis further accentuates this porous structure.

A variety of different types of biomass can be used to produce an at least partially graphitised carbonaceous product. In some cases, it may be advantageous to process the biomass into small pieces, particles, fines or shavings, as opposed to large pieces. Products produced from randomly orientated biomass particles may be less prone to ballooning or volume increase in the latter stages of the process. In addition, thermal treatment under load may result in a higher volume release of volatiles for the biomass particles. Mechanical strength is an important parameter in the manufacture of commercial anodes and products made using biomass particles or shavings may exhibit higher strength.

When using biomass, there is typically initial softening between about 85 to 130° C., in which free and weakly bound water in the biomass evaporates and the biomass begins to plastically deform. The biomass may be held at a temperature in this initial softening region for a sufficient period of time, typically about an hour, to ensure that the water is expelled and initial softening is complete).

Amorphous lignin and hemicelluloses that bind the cellulose-rich fibres and the biomass together soften as the heating continues. The temperature at which the lignin and hemicellulose are softened is dependent upon the particular type of biomass used. There may be significant variations between the softening temperature of different wood species. For example, the softening temperature range for Radiata pine (Pinus radiatus) is about 210 to 235° C. In contrast, Cyprus pine (Callitris glaucophylla) has a softening temperature range of 265 to 285° C. Woody lignocellulosic biomass may be compressed and heated up to about 225° C. without significant thermal degradation. Accordingly, plastic deformation may be achieved through the softening of lignin and hemicellulose during heating to a temperature above about 200° C.

Densification through plastic deformation of the biomass continues as the applied temperature increases further. In certain embodiments, the density that can be achieved for a particular compressive load peaks at around 220-450° C. Often for a particular compressive load the deformation of lignocellulosic biomass is greatest between 200 and 350° C., with a peak depending on the biomass source. Once above the peak temperature, further increases in density are offset by weight loss associated with pyrolysis of the plastically deformed intermediate product.

During the initial heating of the biomass, low molecular weight volatiles are released. At higher temperatures high molecular weight volatiles, for example heavy tars and oils, are released. Typically, the majority of the organic volatiles are released between about 300 and 400° C., but heavier long chain organic volatiles do continue to be released from the biomass at higher temperatures. The intermediate plastically deformed product is preferably obtained, particularly for metallurgical applications, after the majority of the organic volatiles have been released and so the maximum applied temperature during the initial heating step is usually no more than about 500° C.

To promote the release of volatiles, the biomass may be heated and compressed under a vacuum. In some embodiments, the vacuum is maintained until the intermediate product is formed. In other embodiments, the vacuum may be applied throughout the process to produce the densified and at least partially graphitised products.

During plastic deformation the density of the intermediate product may be controlled by the extent to which the biomass is compressed. The density of the intermediate product is important because it influences the physical properties, such as density and reactivity, of the final carbonaceous product.

Plastic deformation of the biomass during the process of some embodiments may enable shaping of products into geometries that are advantageous for specific applications. For example, the plastically deformed intermediate product may be formed into the shape required of a carbon electrode, such as an anode or cathode. In addition, plastic deformation reduces the porosity of the resulting product. Thus, the process leads to a reduction in the surface area of the treated product, which in turn influences other physical properties of the carbonaceous product. For example, a reduction in surface area may lead to a reduction in reactivity.

Subsequent to formation, the intermediate product is subjected to a second temperature regime. Here the intermediate product is heated to a higher temperature than applied in the first step. The second step also takes place in an oxygen controlled atmosphere, for example in a reducing atmosphere such as under an inert gas. The amount of oxygen in the oxygen controlled atmosphere of the second step may be the same as or different to the amount present in the oxygen controlled atmosphere during the first step, as necessary. For example, the first step may be performed under air to form the intermediate product and the second step may be performed under a nitrogen atmosphere

The intention during the second step is to cause at least partial graphitisation of the intermediate product. Graphitisation is the structural ordering of amorphous carbon creating a layering of graphene molecules. It is a progressive process whereby the material can posses both amorphous carbon with graphite dispersed throughout. The extent of graphitisation can be determined for example by the onset of the peak (002) correlating to the C-axis of the graphite structure obtained using X-ray Diffraction analysis. The parameter to determine the extent of graphitisation by those skilled in the art is the parameter L_{c} which correlates to crystallite size. As graphitisation proceeds, the (002) peak intensifies and narrows.

In this part of the process, steps are taken to ensure that the volume expansion of the intermediate product is limited or avoided. If the plastically deformed samples are not constrained, continued heating to cause graphitisation will cause the material to expand or “balloon” in certain regions. Without being limited by theory, it is believed that this ballooning is due either to the release of residual higher molecular weight volatiles from the mass, or reversion towards the original porous structure and/or stress relief mechanisms as a result of continued heating. In addition, depending upon the extent of the degradation of the polymers in the biomass, the deformation may be partially reversible due to the residual elastic resilience of the biomass. Accordingly, in the process of the present invention the plastically deformed intermediate product may be constrained by use of a container or vessel that has rigid or semi-rigid walls so that any volume expansion of the intermediate product is prevented or limited. In another embodiment volume expansion of the intermediate product during this part of the process may be controlled by application of a load to the product. The load may be the same as in the first stage of the process (in which case there will be no volume expansion) or less than in the first stage of the process (in which case there will be some volume expansion). Irrespective of the particular means employed the invention is to advantageously allow volume expansion and thus density to be controlled. It will be appreciated that the density of the final product can be influenced in this part of the process. Herein the term “constrained” (and variations thereof) is used to embrace those various means by which volume expansion of the intermediate product is controlled.

In some embodiments, the plastically deformed intermediate product may be constrained after heating to a peak temperature of at least 600° C. However, in some embodiments, the compressive load applied to the biomass may be reduced after softening has been achieved, but prior to carbonisation. It may not be necessary to continue compression above the point where the majority of heavy tars have been released and major mass loss occurred i.e. heating of the biomass to a first temperature of around 400° C. The present invention utilises plastic deformation occurring at significantly higher temperatures than conventionally thought, in addition to the initial deformation of the biomass at lower temperatures (i.e. below about 285° C.), to ensure a desirable dense product is produced.

In some embodiments, the biomass is continuously heated throughout the process. However, in some embodiments, the intermediate product may be cooled before it is constrained and heated to the second temperature in order to produce the at least partially graphitised carbonaceous product.

Constraining the intermediate product as it is heated may also have an additional influence over the density of the final product in restricting or preventing ballooning due to release of residual volatiles. Constraining the intermediate plastically deformed product has the effect of slowing the release of the residual volatiles, thereby increasing their residence time within the mass. It is believed that this increase in residence time may increase the conversion or breakdown of these volatiles into carbon within the material and minimising carbon loss through volatile release.

The intermediate product is usually constrained by mechanical means. For example, the intermediate product may be heated within a controlled volume to prevent it from expanding beyond that predetermined volume.

In some embodiments of the process, the biomass is compressed until plastic deformation reaches a maximum. The maximum deformation achieved is a function of load and temperature reached. Other factors influencing the amount of compression are the type of biomass, biomass density and moisture content and the duration for which the biomass is held at temperature.

In some embodiments, the biomass is compressed using a particular load to form the plastically deformed intermediate product. The load applied may then be reduced as the intermediate product is heated to the second temperature. The rate can be instantly or progressively changed at a rate as slow as 100 kg/cm²/hour. The minimum load must be so that the sample is physically constrained.

The second regime of the process is intended to initiate at least partial graphitisation of the plastically deformed product. Graphitisation is the change from amorphous and electrically non-conductive carbon into a more ordered crystalline structure that has an increased electrical conductivity. Until at least partial graphitisation occurs, the plastic deformation and increased density of the material is reversible upon heating. Accordingly, graphitisation is required to lock the structure of the material thus providing crystallographic rigidity to the carbonaceous product, decreasing the likelihood of reversion to a porous structure and enabling a product suitable for the substitution of petroleum coke to be produced. In some embodiments, the carbonaceous product is substantially graphitised. Typically, at least about 10% of the amorphous carbon is graphitised in the second regime. However, in some embodiments, the process is continued until a substantially graphitised product is produced. A substantially graphitised product has properties analogous to high grade carbonaceous products such as calcined petroleum coke and may be suitable for use in the production of carbon anodes. Substantially graphitised products may have a crystallite size (L_{c}) greater than 20 Å, preferably 40-150 Å, and may be at least 99.7 wt % carbon (i.e. less than 0.3 wt % impurities).

Graphitisation commences from about 790° C. and the rate of graphitisation increases with temperature. In the present invention, the plastically deformed intermediate product may be heated to temperatures from 790° C. up to about 1400° C., or potentially higher. That is, the second temperature regime may be one similar to that used commercially in the baking of carbon anodes for aluminium production.

The density of the at least partially graphitised product produced in accordance with the process of the present invention is typically at least 0.8 g/cm³. In some embodiments, the at least partially graphitised product produced in accordance with the process of the present invention may have a density up to 1.1 g/cm³. In some embodiments, the product may have a density of 1.3 g/cm³, and possibly higher. Suitable substitutes for petroleum coke or other fossil carbon sources in metallurgical processes require a density of at least 0.8 g/cm³. In contrast, commercial charcoals produced from renewable materials, such as biomass, range between 0.1 to 0.6 g/cm³, depending upon the starting material and the heating rate and final temperature used for pyrolysis.

The resulting at least partially graphitised product may be a suitable alternative for fossil derived carbon such as petroleum coke and may be used in processes that conventionally use petroleum coke, without any modifications to the known processes being necessary. For example, it may be a complete or partial substitute for petroleum coke in the production of carbon electrodes, such as anodes for aluminium production.

Anodes are presently manufactured from a mixture of petroleum coke, the residual reduction anodes known as butts, and binder pitch which is obtained from the tar. The coke and residual reduction anodes are submitted to crushing, sieving and classifying operations in specific size fractions in such a way that after they are mixed, they may produce the highest “packing” degree attainable so that the amount of binding agent required is minimal. Minimising the use of binding agents is advantageous for the production of anodes with desirable mechanical properties. The pitch is mixed with the pre-heated fractions and heated to past the melting point of the pitch. This operation is carried out in continuous or batch mixers in the temperature range from 80-350° C. depending on the process used.

The resulting mix may be directly used in the electrolytic reduction vats when the aluminium is produced through the Soderberg process for producing the anode required for the reduction process. The anode is usually baked at a temperature of around 900-1000° C.

Alternatively, the mix may also be pressed or compacted in suitable presses or compactors, with or without vacuum, in order to produce green anodes used in pre-baked process. Before being used in the reduction process, the green anodes are baked in special furnaces at a temperature of from 900-1400° C. in order to attain the required physical and chemical properties to be used in furnaces for reducing alumina to primary aluminium.

Using the plastic deformation achieved in the process of the present invention, it may be possible to produce anodes directly from biomass. In one embodiment, the biomass is plastically deformed into predetermined geometry as it is heated to a first temperature to form an anode precursor. The anode precursor is then constrained, so that when it is heated further, a carbon anode with the desired geometry is maintained.

The anode production process of the present invention may enable the production of an anode without requiring any crushing, sieving or classifying of the coke. However, the biomass may need to be divided into particles, chips or fines so that it may be more readily deformed into the required geometry for the anode. It may be advantageous to include a carbonaceous binding agent or pitch, including biopitch, together with the biomass, to aid in forming an anode with the required geometry. However, it may also be possible to produce an anode with the addition of any binding agents. In some embodiments, used anode butts may be crushed and combined with the biomass.

Other uses of the resulting at least partially graphitised product include, but are not limited to, use as a metallurgical reagent, as a fuel in sintering processes, as a fuel, as a reductant or to support the bed in a blast furnace or an integrated steel mill, as a filler in an electrode bake furnace, in sidewall ramming paste, or as a substitute for fossil derived carbon (e.g. petroleum coke, anthracite or coal) or as a diluent when used as a partial substitute.

### BRIEF DESCRIPTION OF THE DRAWINGS

Embodiments of the invention and some other embodiments are described herein, by way of example only, with reference to the following non-limiting drawings.

FIG. 1: Schematic of test rig.

FIG. 2: Cold compression test a) sample before and b) after rupture.

FIG. 3: Typical compression at room temperature with incremental addition of load on a solid sample.

FIG. 4: Effect of load on compaction. Solid Radiata Pine reaching ˜300° C.

FIG. 5: Radiata Pine heated under different loads, ˜300° C., from left to right: 1 kg (0.05 kg/cm²); 100 kg (5 kg/cm²); and 500 kg (25 kg/cm2).

FIG. 6: Effect of temperature: Solid Radiata Pine samples, 500 kg (25 kg/cm²) load.

FIG. 7: Effect of holding temperature at 135° C., 1 hour, to expel water prior to organic volatiles then increasing to 300° C. for Radiata Pine under a 500 kg (25 kg/cm²) load.

FIG. 8: Micrograph image showing possible deposition of pitch formed within sample. Radiata Pine heated under a 500 kg (25 kg/cm²) load to 360° C., in a constraining tube.

FIG. 9: Effect of constraining samples in a metal tube, 500 kg (25 kg/cm²) load.

FIG. 10: Effect of wood species on compression, 500 kg (25 kg/cm²) load at various temperatures and constrained in a metal tube.

FIG. 11: Deformation extent versus external sample temperature on samples compressed under 500 kg (25 kg/cm²) load comparing wood species, constraining sample in a metal tube and a mix of course grains.

FIG. 12: Differential Thermal Analysis (DTA) showing mass loss and energy curves for Pinus Radiata, heating rate 2° C./minute up to 300° C. in N₂ flow.

FIG. 13: Effect of temperature reached on maximum deformation achieved. Samples compressed under a 500 kg load (25 kg/cm²).

FIG. 14: Micrograph images of samples compressed at various temperatures—
a) Standard Radiata pine charcoal without compression, 650° C., ρ=0.16 g/cm³.
b) Radiata pine 1 kg load 300° C. no tube (final density not recorded)
c) Radiata pine partially compressed 345° C., 500 kg load (25 kg/cm²), ρ=0.70 g/cm³.
d) Radiata pine severely compressed 360° C., 500 kg load in tube (25 kg/cm²), ρ=0.9 g/cm³.
e) Cypress pine severely compressed 360° C., 500 kg load in tube (25 kg/cm²), ρ=0.87 g/cm³ showing sample surface in top right corner
f) Compressed grain mix Radiata pine showing various grain borders (two highlighted) 360° C., 500 kg load (25 kg/cm²), ρ=1 g/cm³.

FIG. 15: Density of samples compressed (500 kg=25kg/cm²) and heated to various temperatures. Data at 650° C. were portions of compressed samples (indicated by arrows) that were heated to 650° C. in a N₂ atmosphere without applied load.

FIG. 16: Samples of a) original Radiata b) heated under load 500 kg (25 kg/cm²) to 300° C. till maximum compression achieved and c) portion of sample from b) charred without load in a nitrogen atmosphere to 650° C. for four hours. Australian 10 cent coin in foreground for size comparison: 3 mm thick.

FIG. 17: Solids yield comparing compression at various temperatures (500 kg (25 kg/cm²) load except where stated otherwise) and charring without load at 650° C.

FIG. 18: Micrograph images of portions of samples compressed under load during heating and after charring by heating unconstrained to 650° C. in N₂ atmosphere—a) grain mix Radiata Pine 360° C., 500 kg (25 kg/cm²) load, and b) portion charred.

FIG. 19: Micrograph images of portions of samples compressed under load during heating and after charring by heating unconstrained to 650° C. in N₂ atmosphere—a) Radiata Pine 360° C. in tube, 500 kg load (25 kg/cm²), and b) portion charred.

FIG. 20: Micrograph of biocoke at various temperatures showing the progressive improvement in carbon matrix: a) 360° C., b) 1000° C. and c) 1250° C.

The invention is illustrated with reference to the following non-limiting examples.

### EXAMPLES

### Example 1

### Wood Softening by Heating Under Load

Materials and Equipment

Solid cores of Pinus Radiata cut perpendicular to the grain from 30 mm section clear of macro deformation such as knots in the wood were used for the majority of tests. Additional tests using Pinus Radiata coarse shavings and cored Callitris Glaucophylla were conducted to explore and demonstrate the robustness of the exemplary process.

Biomass samples were placed between alumina discs inside a small heating unit. A cantilever beam system applied a known load vertically downwards onto the sample. The load was increased by increasing mass attached to the cantilever. Certain samples were constrained in a metal tube slightly larger than wooden discs. In final tests the tube was packed with Pinus Radiata to investigate pyrolysis of randomly orientated woody biomass.

Green moisture content (% MC) was estimated using a Delmhorst BD-2100 hand held unit which determines the percent of moisture based on the resistance between two pins that are inserted into the sample. The range of the unit for wood analysis is 6-40% MC.

Conducting the pyrolysis under pressure in a modified consolidometer enabled temperature profiles and vertical displacement to be recorded throughout the run.

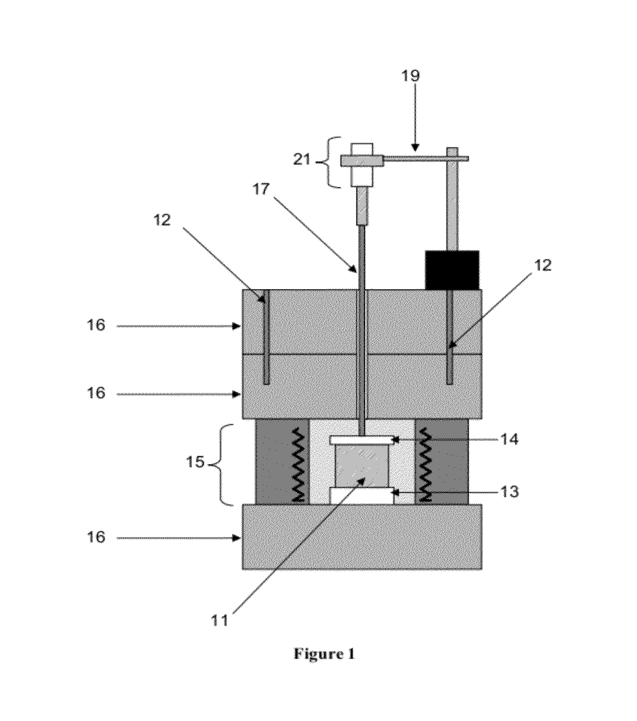

FIG. 1 is a schematic of the test rig used. The cylindrical biomass sample 11 was placed on top of an alumina disc 13 inside the annular furnace 15 and another alumina disc 14 is placed on the top of the sample 11 to distribute the load over the sample surface. The sample 11 is insulated from the external environment using refractory bricks 16 held in place using loading pins 12. A silicon carbide rod 17 (17 cm long) is used to transfer the load from a spherically seated “pin” of a loading beam 19. A linear variable differential transformer (LVDT) 21 measures and monitors the displacement of the beam 19 as the sample is progressively compressed sending an electrical signal to a computer database. Automatic data logging records sample temperature (external and internal) and vertical displacement. The cantilever is loaded to a particular compression force by the addition of weights.

Three thermocouples are suitably positioned to monitor various temperatures. One thermocouple is positioned to measure the internal temperature of the sample 11. It is inserted into the sample 11 through an opening in one of the alumina disc 13. A second thermocouple contacts an external surface of the sample 11 to measure the external temperature of the sample 11. A third thermocouple is used to monitor the temperature of the furnace liner for the purpose of providing feedback for furnace temperature control.

At the completion of each experiment, the final density of the sample was estimated from the final mass and external dimensions as a cross reference to the recorded data. Non-linear and uneven compression compromises the accuracy of this method and averages were used from at least five measurement points.

The yield of char was calculated by dividing the mass of recovered char by the original mass of biomass in each test.

Experiment Parameters and Effects

Twenty six runs were performed to investigate the effect of temperature and pressure as detailed in Table 1 below. All samples were in solid cores except one, Run 25, which was a mixture of coarse shavings lightly packed into a metal tube that snugly fitted around the alumina discs and this acted to semi seal the system. The metal tube was also used to surround solid samples and constrain the spread of softened material during pyrolysis. All runs shown in Table 1 were performed under air.

The moisture content of the samples measured prior to analysis, ranged from 5.9 to 7.3% and was considered to be relatively consistent.

TABLE 1
Physical conditions of compaction experiments.

| | | | | | | Sample | |
|---|---|---|---|---|---|---|---|
| | | | | Di- | | Ext. | |
| | | | Height | ameter | Mass | Temp | |
| Run | Wood | Form | (mm) | (mm) | (g) | (° C.) | Load (kg) |
| 1 | P | solid | 50.92 | 48.47 | 42.3 | 300 | 1 |
| 2 | C | solid | 51.27 | 48.81 | 66.45 | 300 | 10 |
| 3 | P | solid | 50.45 | NR | NR | 290 | 100 |
| 4 | P | solid | 50.83 | NR | NR | 260 | 100 |
| | | | | | | (held at | |
| | | | | | | 75 for | |
| | | | | | | 20 hrs) | |
| 5 | P | solid | 50.53 | 48.75 | NR | Room | Till rupture |
| | | | | | | ~20 | to determine |
| | | | | | | | compressive |
| | | | | | | | strength |
| 6 | P | solid | 49.15 | 49.22 | 43.62 | 220 | 500 |
| 7 | P | solid | 49.94 | 49.04 | 43.21 | 290 | 500 |
| 8 | P | solid | 25.72 | 48.91 | 16.58 | 240 | 500 |
| 9 | P | solid | 25.61 | 48.71 | 17.54 | 290 | 500 |
| 10 | P | solid | 25.39 | 48.77 | 17.84 | 300 | 500 |
| 11 | P | solid | 25.27 | 48.88 | 17.78 | 310 | 500 |
| 12 | P | solid | 25.28 | 48.44 | 17.36 | 230 | 500 |
| 13 | P | solid | 25.78 | 48.72 | 18.31 | 245 | 500 |
| 14 | P | solid | 25.80 | 48.70 | 18.76 | 260 | 500 |
| 15 | P | solid | 25.43 | 48.97 | 18.66 | 330 | 500 |
| 16 | P | solid | 25.71 | 48.77 | 16.53 | 350 | 500 |
| 17 | P | solid | 25.35 | 48.84 | 19.97 | 323 | 500 |
| 18 | P (T) | solid | 26.20 | 49.03 | 19.44 | 325 | 500 |
| 19 | P (T) | solid | 25.64 | 48.84 | 18.13 | 360 | 500 |
| 20 | C (T) | solid | 24.22 | 48.82 | 30.33 | 360 | 500 |
| 21 | C (T) | solid | 23.13 | 48.93 | 28.82 | 345 | 500 |
| 22 | P (T) | solid | 23.34 | 48.89 | 19.09 | 250 | 500 |
| 23 | C (T) | solid | 23.73 | 48.78 | 29.53 | 265 | 500 |
| 24 | C (T) | solid | 23.75 | 48.87 | 31.28 | 300 | 500 |
| 25 | P (T) | chips | 33.77 | 60.77 | 20.00 | 335 | 500 |
| 26 | P (T) | solid | 23.79 | 49.00 | 20.74 | 200 | 500 |

P = Pinus Radiata,
C = Callitris Glaucophylla,
NR = Not Recorded,
(T) = Sample in constraining metal tube

Effect of Compression Load

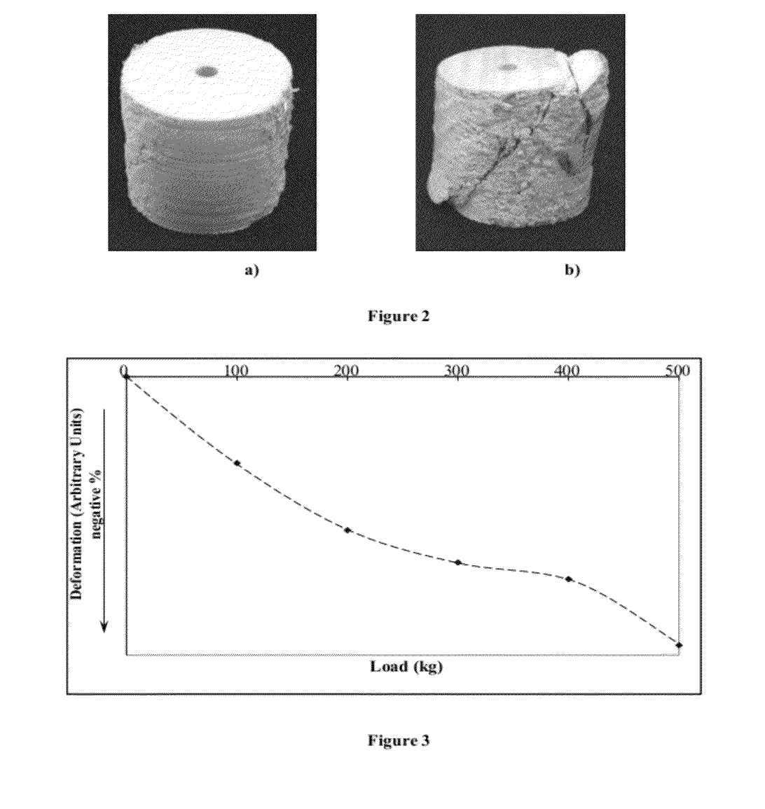

A cold compression test using a Shimadzu RH 10, universal testing machine showed that the Pinus Radiata of Run 5 failed under 13.8 kN of compressive load, see FIGS. 2a) and 2b) which show the sample before (FIG. 2a)) and after rupture (FIG. 2b)). This is equivalent to a compressive stress of 7.6 MPa. This value is around the middle of the published values of compressive failure stress for typical timbers, which spread ranging from 3 to 14 MPa. For a 48.75 mm diameter sample this is equivalent to 1.45 tonne load. A maximum of a third of this pressure was used in compression load during the majority of experiments.

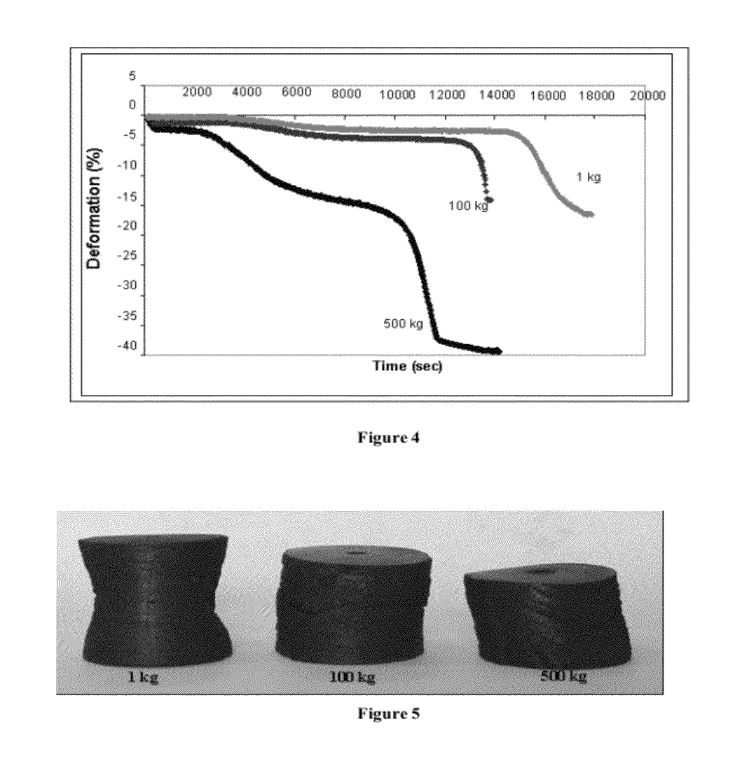

FIG. 3 is a typical deformation under load curve for the samples (excluding the sample comprised of course grains) compressed under load at room temperature in the consolidometer. FIG. 3 suggests a reasonably linear response to load. Typically, a load of 500 kg load resulted in deformation of between 3-4%.

FIG. 4 shows the degree of compaction achieved by applying three different loads: 1 kg, 10 kg and 500 kg, while heating the samples to 300° C. A higher initial load results in greater compaction at a faster rate.

FIG. 5 shows the products resulting from these tests. Carbonisation begins to occur from a temperature ˜270° C. and the blackened surface of the products of these tests suggest some charring has occurred.

Effect of Temperature

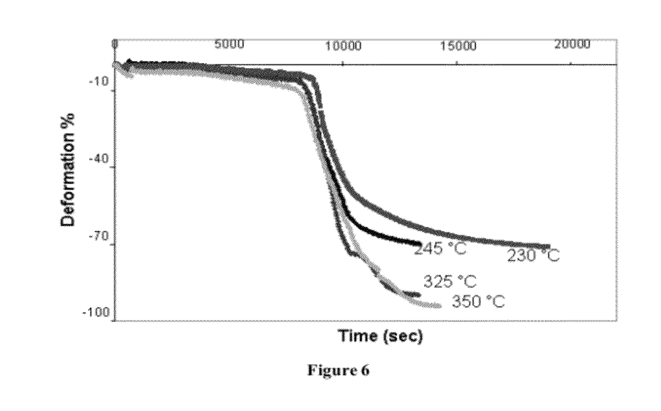

The maximum deformation achieved is dependent on final pyrolysis temperature (see FIG. 6). In a series of experiments spanning 230° C. to 350° C. the deformation extent increased from about 75% to about 95% of the initial sample thickness with increasing temperature. This is significantly greater than the 4% deformation achieved on cold samples under identical loading.

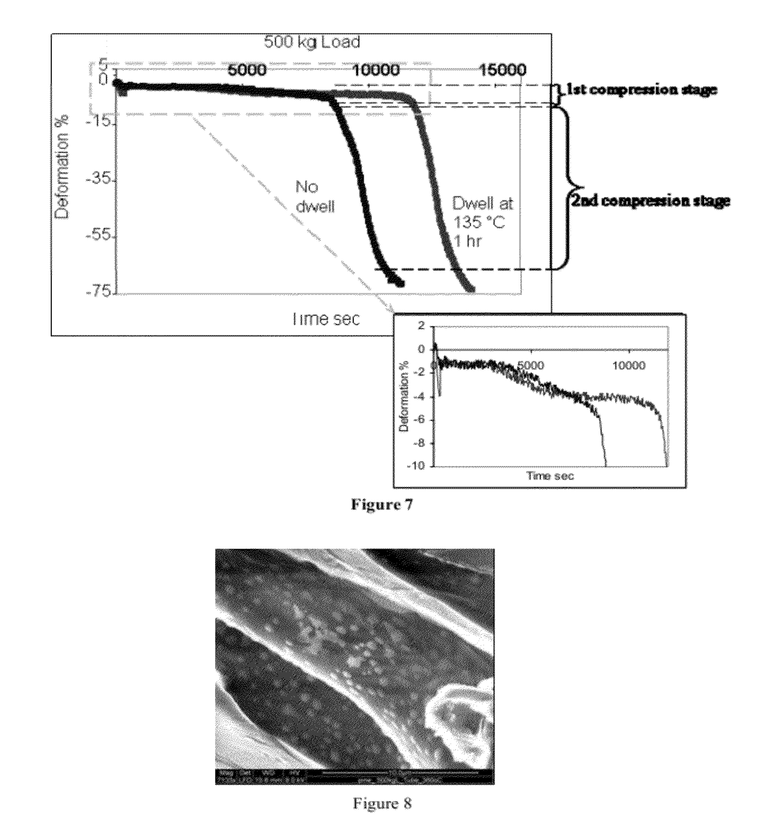

FIG. 7 is a graph of the results of experiments conducted to evaluate the effect of holding the temperature at 135° C. for an hour to expel freely bound water prior to the organics volatilisation. This result suggests that other than delaying the process, it does not appear to have any significant effect on the final extent of deformation.

Two significant regions of deformation are evident in most results. In FIG. 7 for example, the first period of deformation appears to be associated with shrinkage due to the drying of the timber, while the second and more substantial deformation is anticipated to be associated with the softening effect. The temperature range of softening is explained further below.

Effect of Constraining Sample in a Metal Tube

It is anticipated that placing the sample within a metal tube inhibits air ingress and prolongs the residence time of organic volatiles. The slowing of the release of volatiles may contribute to polymerisation of the organics into a high molecular weight and higher boiling point carbon enriched pitch (see FIG. 8) and a subsequent increase in product yield. The generation of “beads” on the surface has been observed previously on distillation of condensate specifically to produce biopitch. Also, while lignin is highly hydrophobic, its softening point decreases in the presence of moisture. Constraining the sample may retain moisture for a longer time allowing more compression to occur at a given temperature.

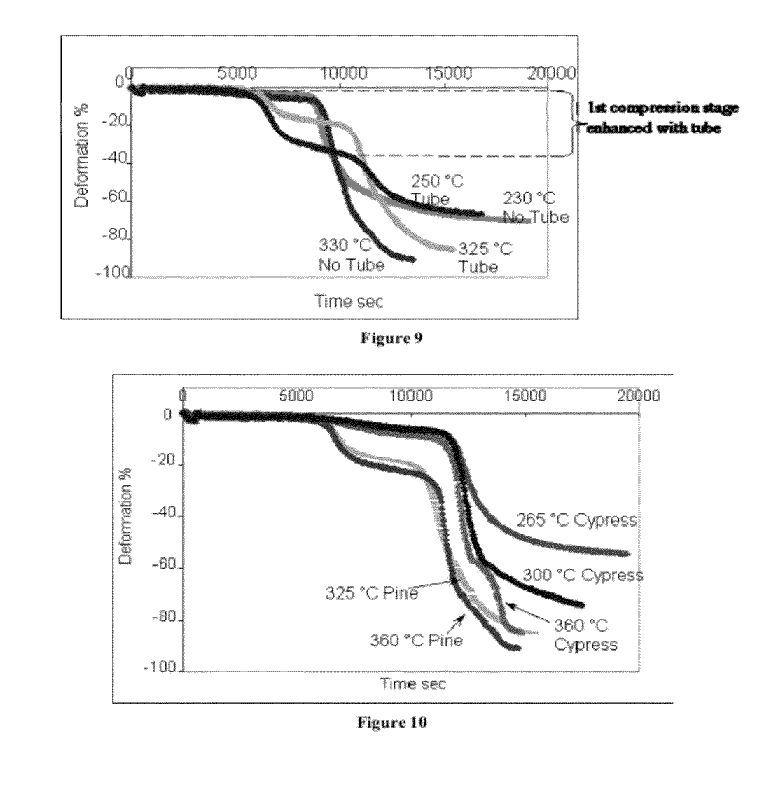

In “constrained” samples, the first stage of softening is enhanced (see FIG. 9) contributing to maximising density. The slightly lower total deformation measured for “constrained” samples may be due to a combination of i) restriction of horizontal displacement and ii) increased carbon associated with a longer residence time.

Comparing Two Species of Wood Biomass

The average dry green density for the Pinus Radiata was 0.4 g/cm³ and Callitris Glaucophylla was 0.69 g/cm³. FIG. 10 shows that the denser Cypress achieves overall slightly less maximum compression than the less dense Radiata. However, the two species reached a similar final density within the errors of the experimental setup and measurement of density. For example, at a temperature of 360° C., the Cypress pine achieved a final density of 0.87 g/cm³ which was only slightly less than that for Radiata pine achieving 0.91 g/cm³. Both samples were constrained within the metal tube.

Results indicate that density after softening is influenced more strongly by time, temperature and pressure than species or green density.

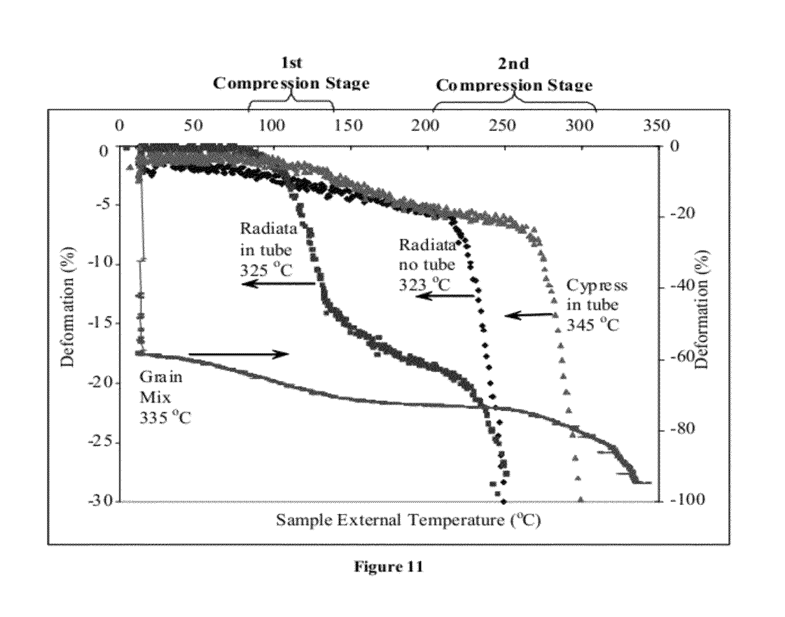

Two significant regions of softening have been identified, as illustrated in the plot of deformation extent against sample external temperature shown in FIG. 11) are:
1: During evaporation of free and weakly bound water and light volatiles.

| | |
|---|---|
| Both Species | 85-130° C. |

2: Softening of Lignin and Hemicelluloses that bind the fibres and is correlated with organic volatiles release. Different temperature ranges of softening were observed for the two species investigated.

| | |
|---|---|
| Pinus Radiata | 210-235° C. |
| Callitris Glaucophylla | 265-285° C. |

The sample containing Pinus Radiata shavings softened in a region around 255° C., about 30° C. higher than its solid counterpart.

Plastic deformation under load continues to a lesser extent at temperatures greater than 285° C.

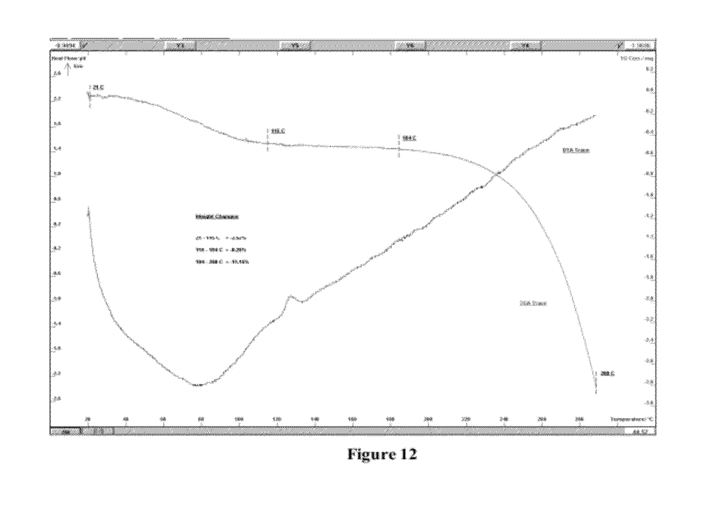

Differential Thermal Analysis (DTA—SETARAM TGA-DTA 92) was performed on a Pinus Radiata sample (˜20 mg) giving mass loss curves for a heating rate of 2° C./minute up to 300° C. in a nitrogen atmosphere (see FIG. 12). The temperature region of major mass loss is consistent with the temperature range of significant softening as shown in FIG. 11. The DTA indicates that the onset of softening of the Pinus Radiata is 185° C. and the turning point in the temperature range 210-240° C. similar to that found in the compression data.

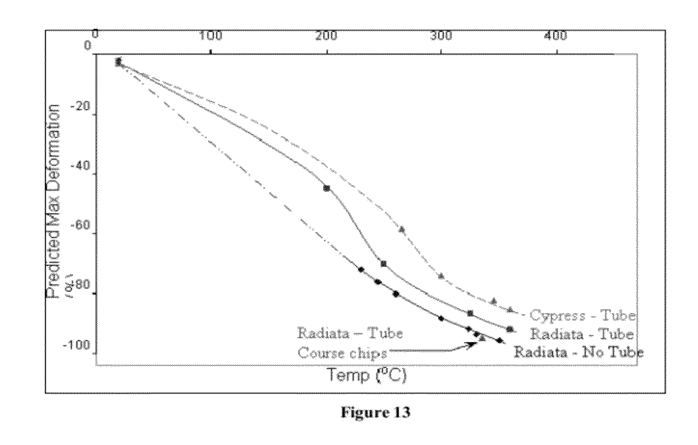

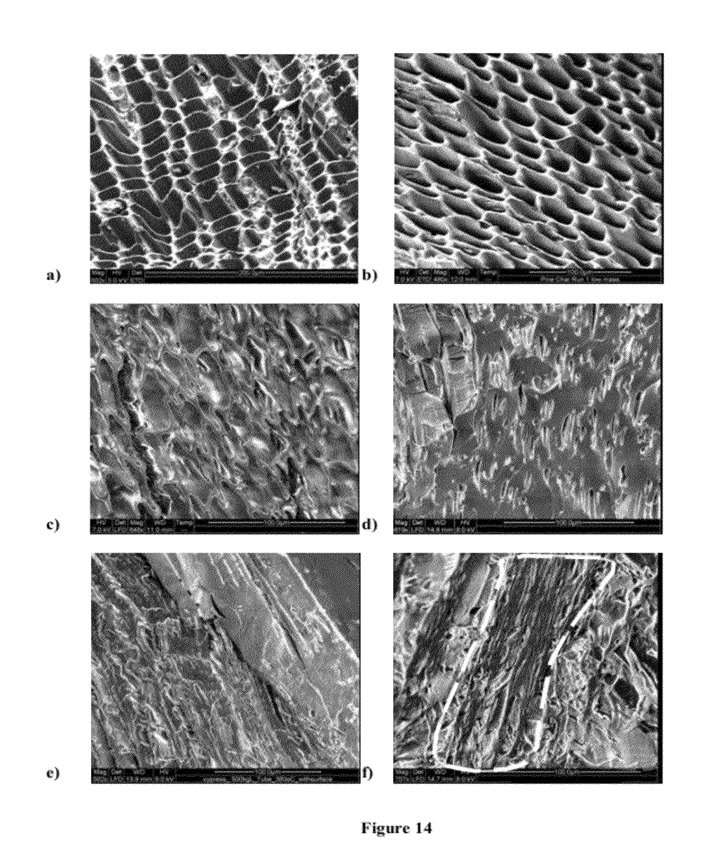

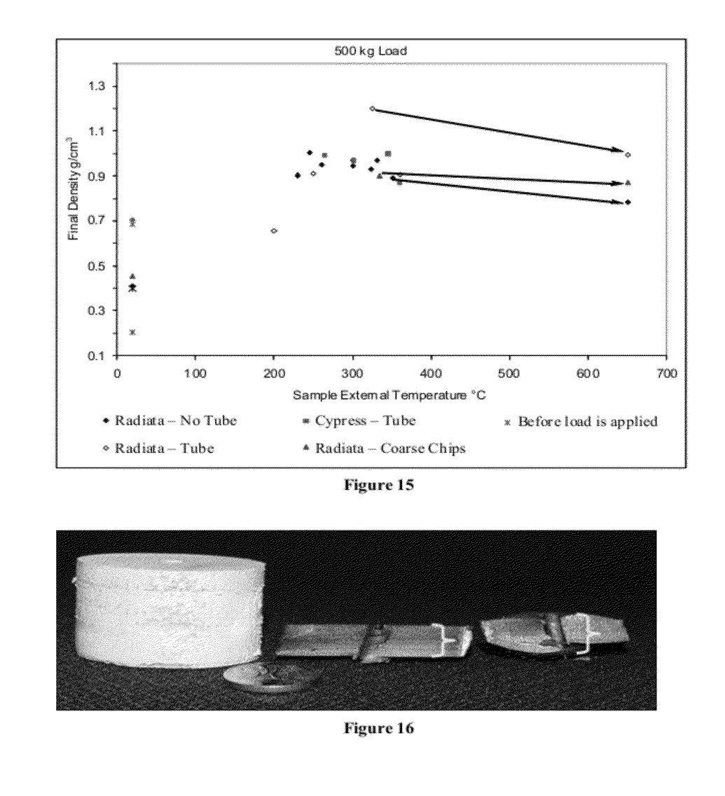

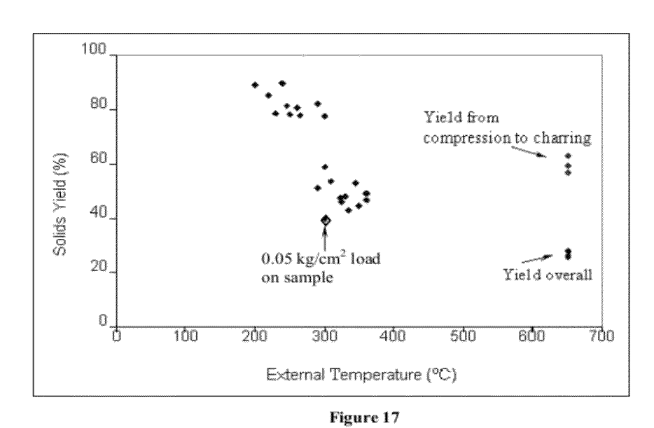

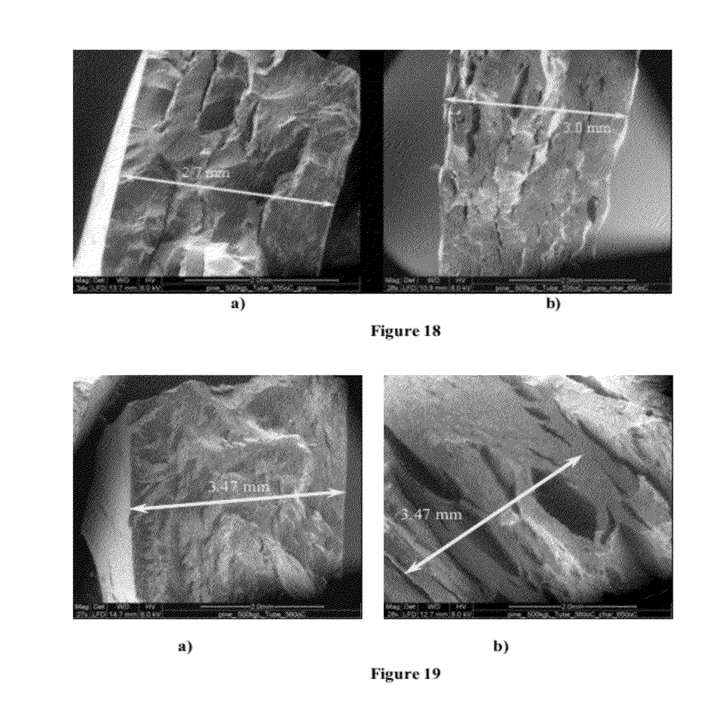

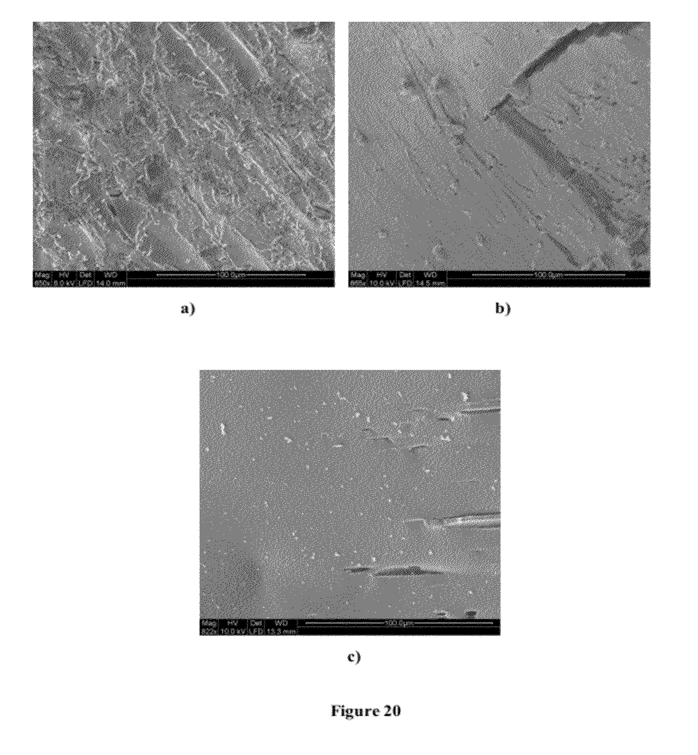

These experiments indicate there is a maximum deformation achieved for each temperature and that the deformation rates slow as the sample approaches its maximum. Increasing the temperature increases the maximum deformation achieved. FIG. 13 presents the extrapolated maximum deformation for each temperature. The results suggest that deformation extent is greatest between 200 and 300° C. and beyond 400° C. the gains in compression decrease. Between 200 and 400° C. it is possible that the original biomass pores collapse during softening and there is porosity created by the significant release of volatiles across this temperature zone. This is illustrated in FIGS. 14a), 14b) and 14c).

Densities and Charring at Higher Temperatures

The approximate densities of samples heated under load of 500 kg at various temperatures <360° C. are given in FIG. 15. The majority of the results were within 0.87 and 1 g/cm³.

Initially, the density of the biomass products under load increased with temperature. The density increase of a sample heated to 200° C. (i.e. 0.4 to 0.66 g/cm³) is attributed to the onset of softening and yielding of the sample to the mechanically applied load. There was little evidence of pyrolysis occurring with only slight discolouration observed.

Between about 200° C. to 260° C. much of the lignin and hemicelluloses has softened and the increase in density can be attributed to the ongoing collapse of pores under load. While deformation continues to higher temperature, density appears to peak around 300° C. because weight loss associated with pyrolysis offsets deformation.

One sample heated at 325° C. under load reached a high density of 1.2 g/cm³ but when heated to 650° C. in a nitrogen atmosphere without any constraint, experienced a large decrease in density. A “ballooning of the product was observed to result from the further heating. This is likely to be due to a combination of volatilisation of residual higher boiling point organic compounds, stress relief mechanisms and reversion associated with residual plastic memory.

Three samples were heated under load of 500 kg at temperatures of 325° C., 335° C. and 360° C. respectively. The samples were broken and a portion (˜⅕ of the sample) was heated in a nitrogen atmosphere to 650° C. for four hours in a tube furnace. On average for solid biomass cores, the density decreased by 0.21 g/cm³ for samples previously compressed up to 325° C. in a metal tube and 0.11 g/cm³ for samples compressed up to 350° C. not constrained in a tube. This has been attributed to a combination of porosity created as higher temperature volatiles are released and “ballooning” (see FIGS. 15 and 16). The sample prepared from wood shavings recorded a significantly lower density decrease (0.02 g/cm³) when pyrolysed to 650° C. possibly because the randomly orientated biomass particles were less prone to reversion and the higher thermal treatment under load had allowed a higher volume release of volatiles. Anecdotally, the char produced from the wood shavings exhibited higher strength and required significant force to break.

The density of each of the portions heated to 650° C. was close to 1 g/cm³. For example, the density of one sample, estimated from mass and volume, sank rapidly in water indicating a density >1 g/cm³. Another sample heated to 650° C. floated just below the surface indicating a density very close to, but less than, 1 g/cm³.

Charring Yields

The yields of solids at the various temperatures are given in Table 2 and results for Runs 1 and 5 to 22 are presented in FIG. 17. Runs 1 to 22 were performed under air. The remaining runs shown in Table 2 used larger sample masses and were performed in a nitrogen atmosphere.

Runs that are shown in Table 2 as being held at temperature for 0 hours are brought to temperature at the rate shown in the preceding column of Table 2 and then allowed to cool, without being held at the final temperature.

Runs 1 to 14, 17 to 20 and 22 to 28 illustrate the effect of the initial heating regime under various conditions. Runs 15, 16 and 20 are comparative examples illustrating the effect upon final density of heating plastically deformed intermediate products further without constraint.

The process in accordance with the present invention is exemplified by Runs 29, 30 and 31. Run 31 illustrates that, after the product has been at least partially graphitised at 1000° C., it can be further heated to 1400° C. unconstrained without any significant loss of density.

Run 32 is an example in accordance with the present invention, although in comparison to Runs 29, 30 and 31 it illustrates that higher compressive loads during the first heating stage, i.e. when plastic deformation predominantly occurs, have a beneficial effect upon final product density.

Run 33 is a comparative example illustrating the effect of heating biomass to 1000° C. without any constraint.

Results suggest that the yield increases when compressive forces are maintained to higher temperatures. For example, samples charred at 650° C. from 325 and 335° C. compression tests, yielded 26.29% and 25.61% in final solids respectively, whereas samples charred from 350° C. and 360° C. compression tests, yielded 28.06% and 27.71%, respectively. In these examples, maintaining the compressive forces while increasing the temperature from 330 to 365° C. increased the yield of solids by ˜7%.

The charcoal yields measured in these experiments are at the higher end for commercial char production where large scale production can achieve up to 32% depending on conditions such as the temperature reached, species of biomass and moisture content.

TABLE 2
Charring yields based on solids recovered after testing.

| | | | | | | | | | | Apparent | |
|---|---|---|---|---|---|---|---|---|---|---|---|
| | | | | | Sample | | | | | Density | Apparent |
| | | | | | External | | Time held at | | Solid | before | Density |
| | | | Mass | | Temperature | Heating Rate | Temperature | Final Mass | Yield | heating | after heating |
| Run | Wood | Form | (g) | Load (kg/cm²) | (° C.) | (° C./hour) | (hour) | (g) | (%) | (g/cm³) | (g/cm³) |
| 1 | P | solid | 42.3 | 0.05 | 300 | 100 | 1 | 16.97 | 40.1 | 0.45 | 0.21 |
| 2 | C | solid | 66.45 | 0.5 | 300 | 100 | 0 | NR | NR | — | — |
| 3 | P | solid | NR | 5 | 290 | 100 | 0 | NR | NR | — | — |
| 4 | P | solid | NR | 5 | 260 | 100 | 20 @ 75° C. | NR | NR | — | — |
| | | | | | | | 0 @ 260° C. | | | | |
| 5 | P | solid | 43.62 | 25 | 220 | 100 | 0 | 37.15 | 85.16 | 0.48 | 0.43 |
| 6 | P | solid | 43.21 | 25 | 290 | 100 | 0 | 22.17 | 51.31 | 0.47 | 0.39 |
| 7 | P | solid | 16.58 | 25 | 240 | 100 | 0 | 14.87 | 89.69 | 0.35 | 0.47 |
| 8 | P | solid | 17.54 | 25 | 290 | 100 | 0 | 14.40 | 82.10 | 0.37 | 0.79 |
| 9 | P | solid | 17.84 | 25 | 300 | 100 | 0 | 13.83 | 77.52 | 0.38 | 0.76 |
| 10 | P | solid | 17.78 | 25 up to 245° C. | 310 | 100 | 0 | 9.56 | 53.77 | 0.38 | 0.32 |
| | | | | 1.25 up to 310° C. | | | | | | | |
| 11 | P | solid | 17.36 | 25 | 230 | 100 | 3 | 13.63 | 78.51 | 0.38 | 0.75 |
| 12 | P | solid | 18.31 | 25 | 245 | 100 | 1 | 14.93 | 81.54 | 0.39 | 0.84 |
| 13 | P | solid | 18.76 | 25 | 260 | 100 | 0.5 | 15.17 | 80.86 | 0.40 | 0.80 |
| 14 | P | solid | 18.66 | 25 | 330 | 100 | 0.5 | 8.95 | 47.96 | 0.40 | 0.97 |
| 15 | P | solid | 16.53 | 25 | 350 | 100 | 0.2 | 7.36 | 44.52 | 0.35 | 0.89 |
| | | | | 0 | 650 | 100 | 4 | | 63.03 | 0.89 | 0.74 |
| | | | | overall | | | | | 28.06 | | |
| 16 | P (T) | solid | 19.44 | 25 | 325 | 100 | 0.5 | 8.97 | 46.14 | 0.40 | 1.02 |
| | | | | 0 | 650 | 100 | 4 | | 57.00 | 1.02 | 0.79 |
| | | | | overall | | | | | 26.29 | | |
| 17 | C (T) | solid | 30.33 | 25 | 360 | 100 | 0.2 | 14.93 | 49.22 | 0.68 | 0.87 |
| 18 | C (T) | solid | 28.82 | 25 | 345 | 100 | 0.4 | 15.30 | 53.07 | 0.67 | 1.00 |
| 19 | P (T) | solid | 19.09 | 25 | 250 | 100 | 1.5 | 14.93 | 78.18 | 0.44 | 1.06 |
| 20 | C (T) | solid | 29.53 | 25 | 265 | 100 | 2.3 | 23.00 | 77.90 | 0.68 | 0.99 |
| 21 | P (T) | chips | 20.00 | 25 | 335 | 100 | 0.5 | 8.57 | 42.86 | 0.19 | 0.90 |
| | | | | 0 | 650 | 100 | 4 | | 59.76 | 0.90 | 0.56 |
| | | | | overall | | | | | 25.61 | | |
| 22 | P (T) | solid | 20.74 | 25 | 200 | 100 | 3 | 18.47 | 89.05 | 0.47 | 0.67 |
| 23 | P | chips | 3,200 | 25 | 300 | 100* | 2 | 1,290 | 40.31 | | 0.91 |
| 24 | P | chips+ | 3,200 | 25 | 300 | 100* | 2 | 1,550 | 48.44 | | 1.05 |
| 25 | P | chips | 3,200 | 25 | 340 | 100* | 2 | 1,330 | 41.56 | | 1.05 |
| 26 | J | chips+ | 3,200 | 25 | 360 | 100* | 2 | 1,310 | 40.94 | | 0.92 |
| 27 | J | chips+ | 3,200 | 25 | 380 | 100* | 2 | 1,040 | 32.5 | | 1.04 |
| 28 | S | mulch | 1,500 | 25 | 360 | 100* | 2 | 740 | 49.33 | | 0.97 |
| 29 | J | chips+ | 3,200 | 25 | 370 | 100* | 1.5 | 1,480 | 46.25 | | 1.04 |
| | | | | 0.1 | 1000 | 200 | 2 | 850 | 57.43 | | 0.84 |
| | | | | overall | | | | | 26.56 | | |
| 30 | J | chips | 3,200 | 25 | 360 | 100* | 2 | 1,310 | 40.94 | | 0.92 |
| | | | 198 | 0.1 | 1000 | 200 | 2 | 124 | 62.62 | | 0.83 |
| | | | | Overall | | | | | 25.64 | | |
| 31 | PL | chips+ | 3,000 | 25 | 370 | 100* | 2 | 1,630 | 54.33 | | 1.20 |
| | | | | 0.1 | 1000 | 200 | 2 | 980 | 60.12 | | 1.10 |
| | | | | 0 | 1400 | 500 | 2 | 950 | 97 | | 1.08 |
| | | | | overall | | | | | 31.68 | | |
| 32 | PL | chips | 680 | 0.1 | 1000 | 200 | 2 | 192 | 28.24 | | 0.47 |
| 33 | P | chips | 500 | 0 | 1000 | 200 | 2 | 130 | 26.00 | | 0.16 |

P = Pine, Pinus Radiata,
PL = Pine preleached,
C = Cyprus Pine, Callitris Glaucophylla,
J = Jarrah, Eucalyptus Marginata,
S = Sugar Cane tops and leaves,
+= 10 wt % pyrolysis condensate added to biomass,
NR = Not Recorded,
(T) = In constraining metal tube and
*= The heating rate was reduced to 50° C./hour between 240 and 340° C. to prevent spontaneous combustion at the carbonisation onset (280° C.) when reaction is exothermic.

Electron Microscopy Analysis

Structural observations of samples were carried out using scanning electron microscopy (ESEM). Electronic images of samples at various extents of compression (see FIG. 14) show cell structure during pyrolysis under load. From almost round cells (a) to rectangular (b), the loss of shape while having intact cell walls suggests plastic deformation (c) to finally have a fusion of solid material with many cells indistinguishable ((c) and (d)), and radically reduced porosity and surface area. Retaining intact cell walls is expected to maintain the inherent strength of the structure during pyrolysis, particularly when the final product is intended to have some residual porosity.

The “ballooning” effect of samples (as shown in FIG. 16) when heated to 650° C. in nitrogen atmosphere without applied load is shown in further detail in FIGS. 18 and FIG. 19. The resulting cracks and expansion of some pores are illustrated in FIG. 18b) and FIG. 19b). This effect is attributed to a combination of volatilisation of higher boiling point organics, stress relief and reversion associated with residual plastic memory. Significantly less ballooning was observed for the sample formed from Pinus Radiata shavings.

FIG. 20 shows electronic images of biocoke suitable for anode production, which was produced from biomass in accordance with the present invention, at 360° C. (see FIG. 20a)), 1000° C. (see FIGS. 20b)) and 1250° C. (see FIG. 20c)). These samples illustrate the complete removal of visible porosity at the macro-scale which contributes to the production of biocoke with bulk densities in excess of 0.9 g/cm³ and ash content <0.25 wt %. This is a significant improvement over biocoke products produced using previously developed methods.

A high magnification photomicrograph shown in FIG. 8, suggests beads of high carbon content material have condensed onto the char during pyrolysis. This bead effect was only observed in samples confined within the metal tube. It is suspected that restricting the gas flow during pyrolysis increases the residence time of the volatiles within the sample, increases the extent of polymerisation of vapour phases and increases the amount of vapour phase deposition/coking with the char.

### Example 2

### Direct Comparison of Samples Made From Sugar Cane Biomass

A sample of tops and leaves from sugar cane was heated to 1000° C. at a rate of 200° C./hour and then maintained for two hours with an applied load pressure of 0.1 kg/cm² in a nitrogen atmosphere resulted in a low vibrated bulk density (0.78 g/cm³) carbon product but higher vibrated bulk density than if pyrolysed without an applied load (0.09 g/cm³).

### Example 3

### Leaching Pre-Treatment

In a larger scale production, biomass (using Pinus Radiata chips) was leached with acetic acid solution (15% in water) in a ratio of 0.5 kg to 1 L for an hour at boiling point. The woody material was filtered and washed thoroughly in water and allowed to dry at 70° C. The ash content reduced from 0.34 wt % for original biomass to 0.05 wt % for leached product. To the leached dry product, condensate from previous pryolysis runs was added in a proportion of 10 wt %. The condensate consisted primarily of the heavy tars and oils. The material was then compressed to 360° C. with a load pressure of 25 kg/cm² under a nitrogen atmosphere in a heating die which allows escape of volatiles from the sides. Heating rate was 100° C./hour until carbonisation starts around 280° C. where the heating rate is reduced to 50° C./hour to eliminate explosive effect with volatile release and after 340° C. the rate is increased again to 100° C./hour to 360° C. and temperature maintained for two hours. The apparent density of sample was 1.2 g/cm³ and the vibrated bulk density was 0.68 g/cm³ The sample was then heated to 1000° C. with a load pressure of 0.1 kg/cm² in a nitrogen atmosphere and temperature maintained for two hours. The apparent density of the sample was 1.1 g/cm³ and the vibrated bulk density was 0.93 g/cm³. The sample was then heated to 1400° C. without constraint for two hours. The vibrated bulk density of the final product was 0.91 g/cm³. The crystallite size on the final product, as determined via X-ray Diffraction analysis, was L_{c}=17 Å, in comparison to anode grade petroleum coke which is usually between 20 and 40 Å, although can vary from this.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Embodiments have been described herein with reference to the accompanying drawings. However, some modifications to the described embodiments may be made without departing from the spirit and scope of the described embodiments, as described in the appended claims.

1. A process for producing densified and at least partially graphitised carbonaceous product, the process comprising:
heating a biomass in an oxygen controlled atmosphere to a first temperature under compression to form a plastically deformed intermediate product; and
heating the plastically deformed intermediate product in an oxygen controlled atmosphere to a second temperature that is higher than the first temperature while constraining the intermediate product to limit or avoid volume expansion to form the densified and at least partially graphitised carbonaceous product.

2. A process according to claim 1, wherein the biomass is pre-treated by heating, pelletising or briquetting.

3. A process according to claim 1, wherein the biomass is pre-treated by leaching in an acid or alkali solution.

4. A process according to claim 1, wherein the biomass includes an additive to improve the catalytic or binding properties of the densified and at least partially graphitised carbonaceous product.

5. A process according to claim 1, wherein the plastically deformed intermediate product is heated so that the densified and at least partially graphitised carbonaceous product formed is substantially graphitised.

6. A process according to claim 1, wherein during compression to form the plastically deformed intermediate product the compressive load is progressively increased to a maximum applied compressive load.

7. A process according to claim 1, wherein during compression to form the plastically deformed intermediate product a maximum applied compressive load is between about 5 to about 50 kg/cm².

8. A process according to claim 1, wherein the plastically deformed intermediate product is deformed into a shape corresponding to the shape of a final product formed of the at least partially graphitised carbonaceous product.

9. A process according to claim 8, wherein the final product is a carbon electrode.

10. A process according to claim 1, wherein the oxygen controlled atmosphere is provided by conducting the process under nitrogen gas.

11. A process according to claim 1, wherein the oxygen controlled atmosphere is provided by conducting the process under vacuum.

12. A process according to claim 1, wherein the first temperature is between 350° C. and 450° C.

13. A process according to claim 1, wherein the second temperature is about 1000° C.

14. A densified and at least partially graphitised carbonaceous product produced according to the process of claim 1.

15. A process according to claim 6, wherein during compression to form the plastically deformed intermediate product a maximum applied compressive load is between about 5 to about 50 kg/cm².

16. A process according to claim 6, wherein the plastically deformed intermediate product is deformed into a shape corresponding to the shape of a final product formed of the at least partially graphitised carbonaceous product.

17. A process according to claim 16, wherein the final product is a carbon electrode.
